(19) United States
(12) Patent Application Publication
(10) Pub. No.: US 2026/0167287 A1
(43) Pub. Date: Jun. 18, 2026

(54) CONNECTOR STRUCTURE OF VEHICLE

(71) Applicants: HYUNDAI MOTOR COMPANY, SEOUL (KR); KIA CORPORATION, SEOUL (KR)

(72) Inventor: Dong Hyun Kim, Hwaseong-si (KR)

(73) Assignees: HYUNDAI MOTOR COMPANY, SEOUL (KR); KIA CORPORATION, SEOUL (KR)

(21) Appl. No.: 19/339,779

(22) Filed: Sep. 25, 2025

(30) Foreign Application Priority Data
Dec. 12, 2024 (KR) 10-2024-0184703

(51) Int. Cl. B62D 63/02; B60H 1/00; B60P 1/64; B60P 3/14; B62D 24/02; B62D 47/00; F16L 37/36

(52) U.S. Cl. CPC B62D 63/025; B60H 1/00571; B62D 24/02; F16L 37/36; B60P 1/6409; B60P 3/14; B62D 47/00

(57) ABSTRACT

A connector structure of a vehicle including a first body constituting a driving module and a second body coupled to the first body and constituting a space module includes a second body fastening portion provided at the second body and including a fluid path formed therein that is opened when the second body fastening portion is coupled to the first body and is sealed when the second body fastening portion is separated from the first body, and a first body fastening portion provided at the first body and fastened to the second body fastening portion to open the fluid path.

### CROSS REFERENCE TO RELATED APPLICATIONS

This application claims priority to and the benefit of Korean Patent Application No. 10-2024-0184703 filed with the Korean Intellectual Property Office on Dec. 12, 2024, the entire contents of which are incorporated herein by reference.

### BACKGROUND

### (a) Field

The present disclosure relates to a vehicle connector structure, and more particularly, to a connector structure of a vehicle formed by combining an upper body and an underbody.

### (b) Description of the Related Art

A vehicle industry has recently been introducing a new concept of future mobility vision for realizing a human-centered and dynamic future city. One of future mobility solutions is a purpose-built vehicle (PBV) as purpose-based mobility.

The PBV may be an example of an eco-friendly mobile vehicle based on an electric vehicle (EV). The PBV may provide a user with a variety of customized services during a time period of travel from a departure point to a destination point in an unmanned or manned autonomous driving manner.

The PBV may include a cap-type driving module in which a driving device is used and is capable of autonomous driving, and a space module coupled to the driving module and used for cargo transport, passenger transport, a home office, or the like.

Each of the driving module and the space module may include an underbody and an upper body coupled to an upper portion of the underbody and movable together by a driving force of the underbody. Existing structures that enable physical fastening between the underbody and the upper body make it difficult for a fluid to move between two objects that are mostly connected. In order to secure a strong fastening force, a fastening and separation process is complicated and an additional apparatus is often required. A structure such as a quick connector that connects two pipes through which a fluid flows does not provide a strong fastening force between two objects.

### SUMMARY

An embodiment of the present disclosure is intended to provide a connector structure of a vehicle capable of easily fastening and separating an underbody and an upper body in a purpose-built vehicle (PBV), securing a strong fastening force, and allowing a fluid to flow when the underbody and the upper body are fastened.

A connector structure of a vehicle including a first body constituting a driving module and a second body coupled to the first body and constituting a space module according to an embodiment of the present disclosure includes a second body fastening portion that is provided at the second body and includes a fluid path formed therein that is opened when the second body fastening portion is coupled to the first body and is sealed when the second body fastening portion is separated from the first body, and a first body fastening portion that is provided at the first body and is fastened to the second body fastening portion to open the fluid path.

The second body may be coupled to an upper end of the first body.

The second body fastening portion may include a connection cylinder that is fixedly installed at the second body and has a hollow formed thereinside, a piston that is fixedly installed in the hollow inside the connection cylinder and is disposed so that the connection cylinder is relatively moved when the second body fastening portion and the first body fastening portion are fastened, a second spring that is disposed to support the piston in the hollow space inside the connection cylinder and is compressed by a movement of the first body fastening portion when the second body fastening portion and the first body fastening portion are fastened, a second sealing member that is provided on an inner circumferential surface of the connection cylinder, is in contact with an outer circumferential surface of the piston, and is pushed by the first body fastening portion to open the fluid path when the second body fastening portion and the first body fastening portion are fastened, and a support member that is provided inside the connection cylinder, fixes the piston to the connection cylinder, and is installed to contact and support an upper portion of the second spring.

The piston may have a lower end portion formed in a circular shape having a larger radius than that of an upper end portion.

The second sealing member may seal a space between an outer circumferential surface of a lower end portion of the piston and the inner circumferential surface of the connection cylinder, and may release a contact with the lower end portion of the piston when the second body fastening portion and the first body fastening portion are fastened.

The second sealing member may be made of an elastic member.

The second spring may be interposed between an upper side of a lower end portion of the piston and the support member to perform compression and decompression.

A second pressure sensor may be provided at a lower end portion of the connection cylinder to detect a pressure at which the lower end portion of the connection cylinder is in contact with an upper surface of the first body when the second body fastening portion and the first body fastening portion are fastened.

The first body fastening portion may include a hydraulic cylinder that is fixedly installed at the first body, has a hollow formed thereinside, and has an opening formed at an upper end thereof, a first sealing member that is installed to seal the opening of the hydraulic cylinder and is disposed so that the hydraulic cylinder is relatively moved when the second body fastening portion and the first body fastening portion are fastened, a pad that is provided at a lower end of the hydraulic cylinder and protrudes to the outside of the hydraulic cylinder to be in contact with the inner circumferential surface of the connection cylinder so that the hydraulic cylinder and the connection cylinder are fastened and fixed when the second body fastening portion and the first body fastening portion are fastened, and a first spring that is provided on a lower surface of the first sealing member and is compressed between the first sealing member and the first body when the second body fastening portion and the first body fastening portion are fastened.

When the second body fastening portion and the first body fastening portion are fastened, the first sealing member may be in contact with the piston to move relative to the hydraulic cylinder.

The pad may protrude to the outside by a hydraulic pressure when the second body fastening portion and the first body fastening portion are fastened.

The pad may be made of an elastic pad or a drum brake.

A first pressure sensor may be provided at the pad to detect a pressure at which the pad is in contact with the inner circumferential surface of the connection cylinder when the second body fastening portion and the first body fastening portion are fastened.

The first body fastening portion may be inserted into the first body to be fixedly installed at the first body and a rubber packing may be provided on an inner outer circumferential surface of the first body into which the first body fastening portion is inserted, and an outer circumferential surface of the connection cylinder may be in contact with the rubber packing when the second body fastening portion and the first body fastening portion are fastened.

A fluid hose extending toward the first body and through which a fluid flows may be provided on an inner circumferential surface of the hydraulic cylinder.

The first body fastening portion may be inserted into and fixedly installed at the first body, a cross-section of the first body into which the first body fastening portion is inserted may have a trapezoidal shape, and a cross-section of the connection cylinder of the second body fastening portion corresponding to the first body fastening portion may be formed in a trapezoidal shape corresponding to the cross-section of the first body.

A fastening portion may be formed at each of an underbody and an upper body of a purpose-built vehicle (PBV), so that an embodiment of the present disclosure easily fastens and separates the underbody and the upper body, secures a strong and stable fastening force, and allows a fluid to flow when the underbody and the upper body are fastened.

In addition, because fluid flow between the underbody and the upper body is possible when the underbody and the upper body are fastened, a cooling and air conditioning system may be installed only at the underbody so that a space may be secured by reducing price of the upper body and simplifying a structure of the upper body.

In addition, a rubber material may be applied to the fastening portion so that vibration and shock that may occur during a fastening process of the underbody and the upper body and an operation of a vehicle are absorbed and watertightness and airtightness performance is improved.

### BRIEF DESCRIPTION OF THE FIGURES

FIG. 1 is a view showing a state in which a connector structure of a vehicle according to an embodiment of the present disclosure is installed at a second body and a first body.

FIG. 2 is a view showing a state in which the connector structure of the vehicle according to the embodiment of the present disclosure is applied to coupling of the second body and the first body.

FIG. 3 is a view showing a state in which a fluid flows through a fluid path in the connector structure of the vehicle according to the embodiment of the present disclosure.

FIG. 4 is a perspective view showing the connector structure of the vehicle according to an embodiment of the present disclosure.

FIG. 5 is a cross-sectional view showing a state before fastening of the connector structure of the vehicle according to an embodiment of the present disclosure.

FIG. 6 is a cross-sectional view showing a state in which the connector structure of the vehicle is being fastened according to an embodiment of the present disclosure.

FIG. 7 is a cross-sectional view showing a state after fastening of the connector structure of the vehicle according to an embodiment of the present disclosure.

FIG. 8 is a perspective view showing a state in which a first body fastening portion of a connector structure of a vehicle according to an embodiment of the present disclosure is inserted and installed in a first body provided with a rubber packing.

FIG. 9 is a cross-sectional view showing a state in which the first body fastening portion of the connector structure of the vehicle according to an embodiment of the present disclosure is inserted and installed in the first body provided with the rubber packing.

FIG. 10 is a perspective view showing a connector structure of a vehicle according to another embodiment of the present disclosure.

FIG. 11 is a cross-sectional view showing the connector structure of the vehicle according to the other embodiment of the present disclosure.

### DETAILED DESCRIPTION

Embodiments of the present disclosure will be described more fully hereinafter with reference to the accompanying drawings so that those skilled in the art could easily implement the embodiments. The present disclosure may be modified in various ways, all without departing from the spirit or scope of the present disclosure.

A constituent element having the same configuration will be representatively described in an embodiment using the same reference numeral, and only a constituent element of another embodiment different from that of the embodiment will be described.

The drawings are schematic, and are not illustrated in accordance with a scale. Relative dimensions and ratios of portions in the drawings are illustrated to be exaggerated or reduced in a size for clarity and convenience, and the dimensions are just examples and are not limited. Like structures, elements, or components illustrated in two or more drawings use the same reference numerals for showing similar features. It will be understood that when an element such as a layer, film, region, area, or substrate is referred to as being “on” another element, it may be directly on the other element or an intervening element may be present therebetween.

The embodiment of the present disclosure shows one embodiment of the present disclosure in detail. As a result, various modifications of the drawings will be expected. Therefore, the embodiment is not limited to a specific shape of an illustrated region, but, for example, includes a change in the shape in accordance with manufacturing.

Hereinafter, a connector structure of a vehicle according to an embodiment of the present disclosure will be described in detail with reference to the accompanying drawings.

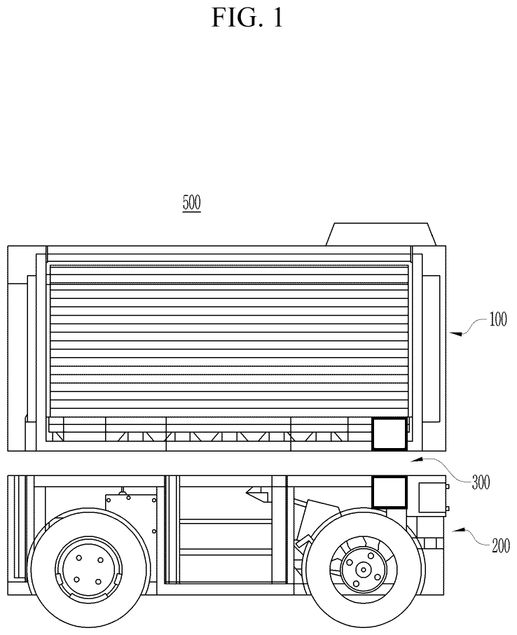

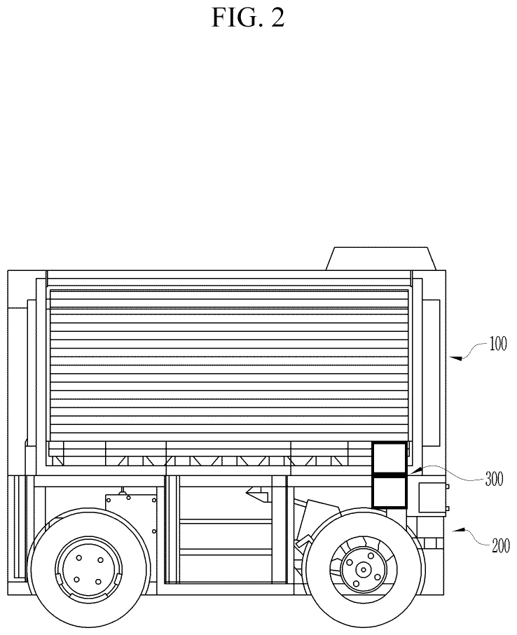

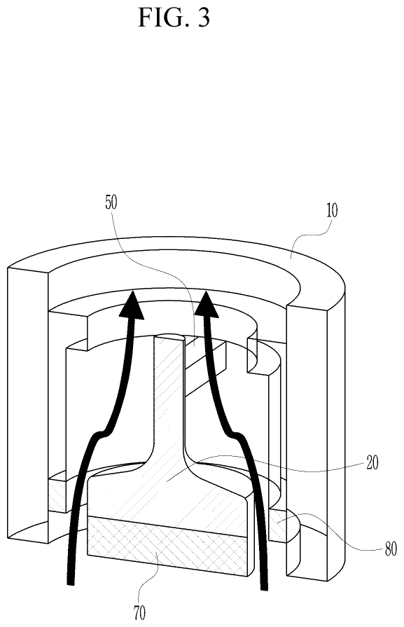

FIG. 1 is a view showing a state in which the connector structure of the vehicle according to the embodiment of the present disclosure is installed at a second body and a first body, FIG. 2 is a view showing a state in which the connector structure of the vehicle according to the embodiment of the present disclosure is applied to coupling of the second body and the first body, and FIG. 3 is a view showing a state in which a fluid flows through a fluid path in the connector structure of the vehicle according to the embodiment of the present disclosure.

Referring to FIG. 1 and FIG. 2, a vehicle 500 may be a purpose-built vehicle (PBV) including a driving module and a space module coupled to an upper portion of the driving module. The driving module may include a driving device and may be capable of autonomous driving, and the space module may be used for cargo transport, passenger transport, a home office, or the like. The driving module and the space module may be fastened or connected to each other in a vertical direction, and when they are separated, the driving module may be driven alone.

In an embodiment of the present disclosure, a first body 200 may be an underbody constituting the driving module, and the second body 100 may be an upper body constituting the space module. The second body 100 may be coupled to an upper end of the first body 200.

The first body 200 and the second body 100 may be formed in a rectangular parallelepiped shape, and may be coupled at four corners thereof. A connector structure 300 may be provided at a portion where the first body 200 and the second body 100 are coupled. The portion may be one portion or a plurality of portions.

The connector structure 300 may include a second body fastening portion 310 and a first body fastening portion 320 each provided at the second body 100 and the first body 200. That is, the second body fastening portion 310 and the first body fastening portion 320 may be coupled to fasten the second body 100 and the first body 200.

As shown in FIG. 3, if the second body fastening portion 310 and the first body fastening portion 320 are coupled, a piston 20 provided at the second body fastening portion 310 may be in contact with a first sealing member 70 provided at the first body fastening portion 320, and a connection cylinder 10 of the second body fastening portion 310 may be lowered to overlap a hydraulic cylinder 60 of the first body fastening portion 320.

In the process, the piston 20 fixed inside a second body fastening portion 310 may push the first sealing member 70 to open an opening of the hydraulic cylinder 60, and the hydraulic cylinder 60 may push a second sealing member 40 to open an opening of the connection cylinder 10. Accordingly, a fluid path may be formed from the hydraulic cylinder 60 to the connection cylinder 10. A fluid circulating in a cooling and air conditioning system installed at the first body 200 through the fluid path may be supplied to the second body 100.

A more detailed fastening process of the second body fastening portion 310 and the first body fastening portion 320 will be described later with reference to the drawings showing the connector structure 300 of the vehicle according to an embodiment of the present disclosure.

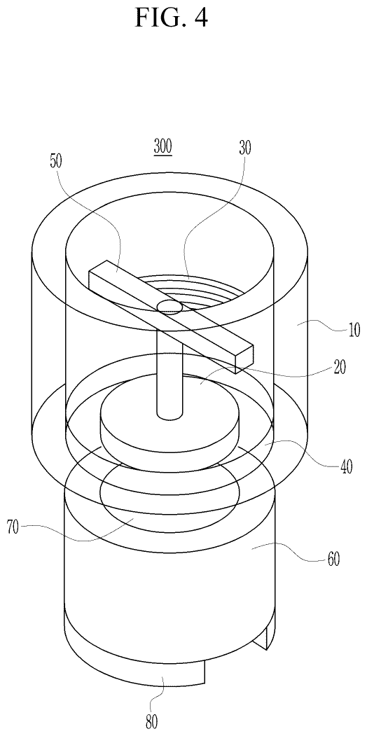

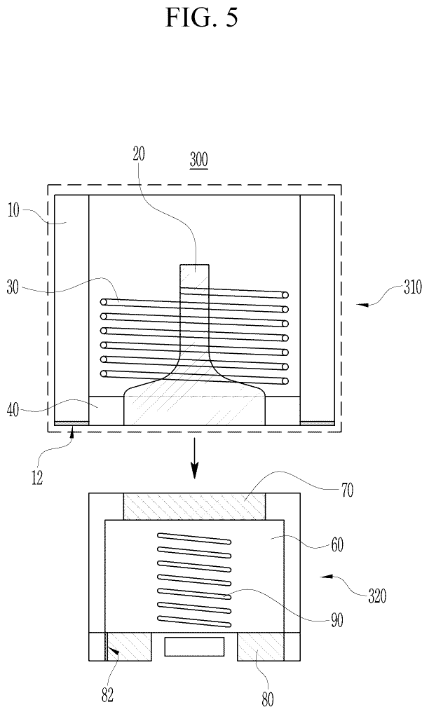

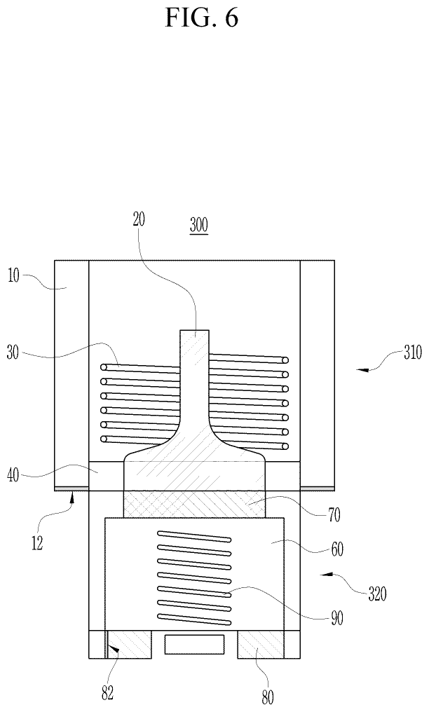

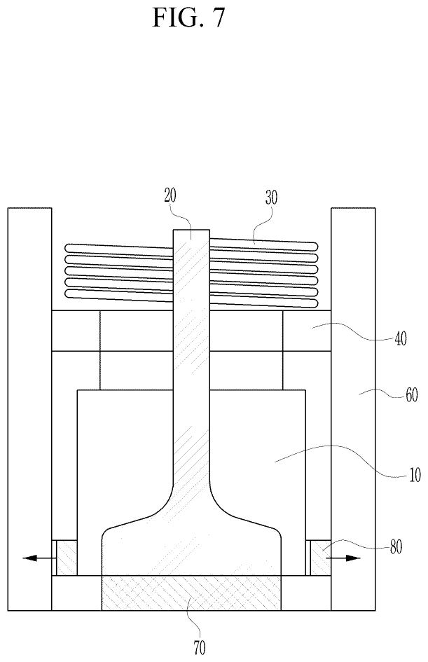

FIG. 4 is a perspective view showing the connector structure of the vehicle according to an embodiment of the present disclosure, FIG. 5 is a cross-sectional view showing a state before fastening of the connector structure of the vehicle according to an embodiment of the present disclosure, FIG. 6 is a cross-sectional view showing a state in which the connector structure of the vehicle is being fastened according to an embodiment of the present disclosure, and FIG. 7 is a cross-sectional view showing a state after fastening of the connector structure of the vehicle according to an embodiment of the present disclosure.

Referring to FIGS. 4 to 7, the vehicle connector structure 300 according to the embodiment of the present disclosure may be provided for coupling of the vehicle 500 including the first body 200 constituting the driving module and the second body 100 coupled to an upper portion of the first body 200 and constituting the space module, and may include the second body fastening portion 310 and the first body fastening portion 320.

The second body fastening portion 310 may be provided at the second body 100, and may include a fluid path formed therein that is opened when it is coupled to the first body 200 and is sealed when it is separated from the first body 200. The first body fastening portion 320 may be provided at the first body 200, and may be fastened to the second body fastening portion 310 to open the fluid path.

The second body fastening portion 310 and the first body fastening portion 320 may have a cylindrical shape in which a hollow or opening is formed, and the first body fastening portion 320 may be inserted into and coupled to the hollow of the second body fastening portion 310.

The second body fastening portion 310 may include the connection cylinder 10, the piston 20, a second spring 30, the second sealing member 40, and a support member 50.

The connection cylinder 10 may be fixedly installed at the second body 100, and may have a hollow or opening formed inside. The connection cylinder 10 may have a shape outwardly protruding at a lower portion of the second body 100. An opening may be formed at each of upper and lower ends of the connection cylinder 10.

The piston 20 may be fixedly installed in the hollow inside the connection cylinder 10, and may have a lower end portion formed in a circular shape having a larger radius than that of an upper end portion. An outer circumferential surface of the lower end portion of the piston 20 may be in contact with the second sealing member 40 to seal a lower opening of the connection cylinder 10.

When the second body fastening portion 310 and the first body fastening portion 320 are fastened, the connection cylinder 10 may be relatively moved in a state in which the piston 20 is fixed.

The second spring 30 may be disposed to support the piston 20 in the hollow inside the connection cylinder 10, and may be compressed by a movement of the first body fastening portion 320 when the second body fastening portion 310 and the first body fastening portion 320 are fastened.

The second spring 30 may be interposed between an upper side of the lower end portion of the piston 20 and the support member 50 to perform compression and decompression. If fastening of the second body fastening portion 310 and the first body fastening portion 320 is separated, the second sealing member 40 may be pushed down by an elastic force of the second spring 30 to seal a lower portion of the connection cylinder 10.

The second sealing member 40 may be provided on an inner circumferential surface of the connection cylinder 10, and may be in contact with an outer circumferential surface of the piston 20 to seal the lower opening of the connection cylinder 10. When the second body fastening portion 310 and the first body fastening portion 320 are fastened, the second sealing member 40 may be pushed to an upper side of the connection cylinder 10 by the first body fastening portion 320 to open the fluid path.

That is, the second sealing member 40 may seal a space between the outer circumferential surface of the lower end portion of the piston 20 and the inner circumferential surface of the connection cylinder 10, and may release a contact with the lower end portion of the piston 20 to open the fluid path when the second body fastening portion 310 and the first body fastening portion 320 are fastened.

The second sealing member 40 may be made of an elastic member such as a rubber.

The support member 50 may be provided inside the connection cylinder 10, may fix the piston 20 to the connection cylinder 10, and may be installed to contact and support an upper portion of the second spring 30. The support member 50 may be formed in a rod shape, and both ends of the support member 50 may be fixed to an inner side surface of the connection cylinder 10. An upper end of the piston 20 may be fixed to a central portion of the support member 50.

A second pressure sensor 12 may be provided at a lower end portion of the connection cylinder 10 to detect a pressure at which the lower end portion of the connection cylinder 10 is in contact with an upper surface of the first body 200 when the second body fastening portion 310 and the first body fastening portion 320 are fastened.

The first body fastening portion 320 may include the hydraulic cylinder 60, the first sealing member 70, a pad 80, and a first spring 90.

The hydraulic cylinder 60 may be fixedly installed at the first body 200, and may have a hollow formed thereinside. The hydraulic cylinder 60 may have a shape inwardly recessed at an upper portion of the first body 200. An opening may be formed at each of upper and lower ends of the hydraulic cylinder 60.

The first sealing member 70 may be provided on an inner circumferential surface of the hydraulic cylinder 60, and may seal the upper opening of the hydraulic cylinder 60. When the second body fastening portion 310 and the first body fastening portion 320 are fastened, the first sealing member 70 may be pushed to a lower side of the hydraulic cylinder 60 by the piston 20 of the second body fastening portion 310 so that the upper opening is opened.

The pad 80 may be provided around the lower opening at a lower end of the hydraulic cylinder 60, and when the second body fastening portion 310 and the first body fastening portion 320 are fastened, the pad 80 may protrude to the outside of the hydraulic cylinder 60 to be in contact with the inner circumferential surface of the connection cylinder 10 so that the hydraulic cylinder 60 and the connection cylinder 10 are fastened and fixed.

The pad 80 may protrude to the outside of the hydraulic cylinder 60 by a hydraulic pressure when the second body fastening portion 310 and the first body fastening portion 320 are fastened. The pad 80 may be made of an elastic pad such as a rubber or a drum brake.

The first spring 90 may be provided on a lower surface of the first sealing member 70, and may be compressed between the first sealing member 70 and the upper surface of the first body 200 when the second body fastening portion 310 and the first body fastening portion 320 are fastened. If fastening of the second body fastening portion 310 and the first body fastening portion 320 is separated, the first sealing member 70 may be pushed up by an elastic force of the first spring 90 to seal the upper opening of the hydraulic cylinder 60.

A first pressure sensor 82 may be provided at the pad 80 to detect a pressure at which the pad 80 is in contact with the inner circumferential surface of the connection cylinder 10 when the second body fastening portion 310 and the first body fastening portion 320 are fastened.

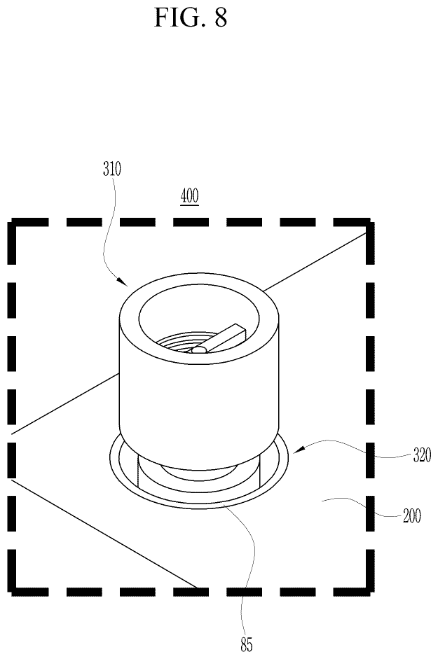

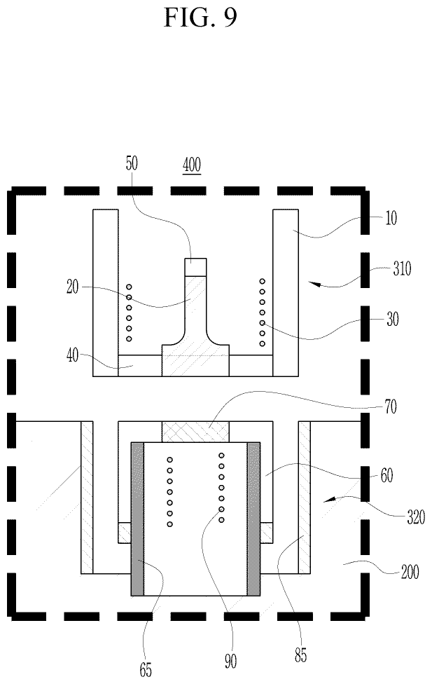

FIG. 8 is a perspective view showing a state in which a first body fastening portion of the connector structure of a vehicle according to an embodiment of the present disclosure is inserted and installed in a first body provided with a rubber packing, and FIG. 9 is a cross-sectional view showing a state in which the first body fastening portion of the connector structure of the vehicle according to an embodiment of the present disclosure is inserted and installed in the first body provided with the rubber packing.

Referring to FIG. 8 and FIG. 9, in a vehicle connector structure 400, a first body fastening portion 320 may be inserted into a first body 200 to be fixedly installed at the first body 200, and a rubber packing 85 may be provided on an inner outer circumferential surface of the first body 200 into which the first body fastening portion 320 is inserted.

When a second body fastening portion 310 and the first body fastening portion 320 are fastened, an outer circumferential surface of a connection cylinder 10 may be in contact with the rubber packing 85. A rubber material may be applied to an inner outer circumferential surface portion of the first body 200 in contact with the outer circumferential surface of the connection cylinder 10, so that vibration and shock that may occur during a fastening process of the first body 200 and a second body 100 and an operation of the vehicle are absorbed and watertightness and airtightness performance is improved.

A fluid hose 65 extending toward the first body 200 and through which a fluid flows may be provided on an inner circumferential surface of a hydraulic cylinder 60. The fluid hose 65 may allow a lower end portion of the hydraulic cylinder 60 to be spaced apart from an inner side of an upper portion of the first body 200. That is, even if the lower end portion of the hydraulic cylinder 60 does not directly contact the first body 200, a fluid inside the first body 200 may be transferred to the second body fastening portion 310 by the fluid hose 65.

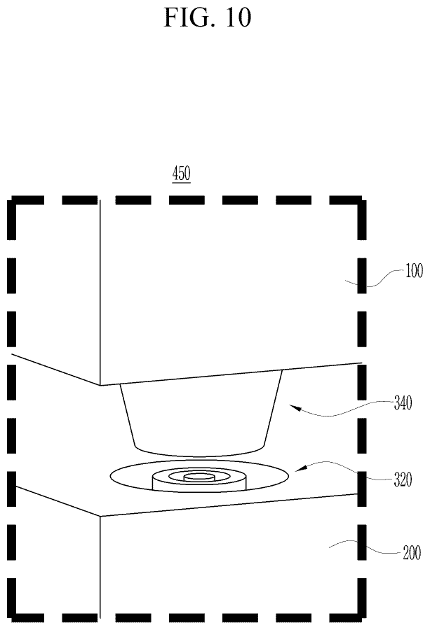

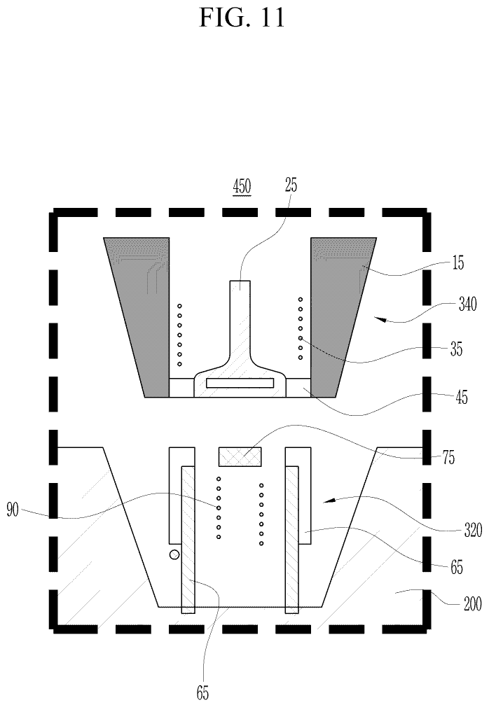

FIG. 10 is a perspective view showing a connector structure of a vehicle according to another embodiment of the present disclosure, and FIG. 11 is a cross-sectional view showing the connector structure of the vehicle according to the other embodiment of the present disclosure.

Referring to FIG. 10 and FIG. 11, in a vehicle connector structure 450 according to the other embodiment of the present disclosure, a first body fastening portion 320 may be inserted into and fixedly installed at a first body 200, and a cross-section of the first body 200 into which the first body fastening portion 320 is inserted may have a trapezoidal shape. In addition, a cross-section of a connection cylinder 10 of a second body fastening portion 310 corresponding to the first body fastening portion 320 may be formed in a trapezoidal shape corresponding to the cross-section of the first body 200.

That is, a recessed inner side of the first body 200 and an outer surface of the connection cylinder 10 may have an inclined shape, and the shape may allow the second body fastening portion 310 to be smoothly fastened to the first body fastening portion 320.

A fluid hose 65 extending toward the first body 200 and through which a fluid flows may be provided on an inner circumferential surface of a hydraulic cylinder 60, and the hydraulic cylinder 60 may be formed of a rubber material. The hydraulic cylinder 60 may be formed of the rubber material, so that vibration and shock that may occur during a fastening process of the first body 200 and a second body 100 and an operation of the vehicle are absorbed and watertightness and airtightness performance is improved.

The fastening portion may be formed at each of the underbody and the upper body of the PBV, so that the embodiment of the present disclosure easily fastens and separates the underbody and the upper body, secures a strong and stable fastening force, and allows the fluid to flow when the underbody and the upper body are fastened.

In addition, because fluid flow between the underbody and the upper body is possible when the underbody and the upper body are fastened, a cooling and air conditioning system may be installed at the underbody so that a space may be secured by reducing price of the upper body and simplifying a structure of the upper body.

In addition, the rubber material may be applied to the fastening portion so that vibration and shock that may occur during a fastening process of the underbody and the upper body and an operation of the vehicle are absorbed and watertightness and airtightness performance is improved.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

1. A connector for coupling of a vehicle including a first body which is a driving module and a second body coupled to the first body, the second body being a space module, comprising:
a second body fastening portion provided at the second body and including a fluid path formed inside, wherein the fluid path is configured to be opened when the second body fastening portion is coupled to the first body, and is configured to be sealed when the second body fastening portion is separated from the first body; and
a first body fastening portion provided at the first body and fastened to the second body fastening portion to open the fluid path.

2. The connector of claim 1, wherein the second body is coupled to an upper end of the first body.

3. The connector of claim 2, wherein the second body fastening portion comprises:
a connection cylinder fixedly connected to the second body and having a hollow space formed therein;
a piston fixedly positioned within the hollow space inside the connection cylinder, and wherein the piston is positioned so that the connection cylinder is moved when the second body fastening portion and the first body fastening portion are fastened;
a first spring positioned to support the piston within the hollow space inside the connection cylinder, and configured to be compressed by a movement of the first body fastening portion when the second body fastening portion and the first body fastening portion are fastened;
a first sealing member positioned on an inner circumferential surface of the connection cylinder, being in contact with an outer circumferential surface of the piston, and configured to be pushed by the first body fastening portion to open the fluid path when the second body fastening portion and the first body fastening portion are fastened; and
a support member positioned inside the connection cylinder and fixedly connects the piston to the connection cylinder, wherein the support member contacts and supports an upper portion of the first spring.

4. The connector of claim 3, wherein the piston has a lower end portion having a circular shape and an upper end portion having a circular shape, wherein the radius of the lower end portion is larger than a radius of the upper end portion.

5. The connector of claim 4, wherein the first sealing member is configured to seal a space between an outer circumferential surface of the lower end portion of the piston and the inner circumferential surface of the connection cylinder, and to release a contact with the lower end portion of the piston when the second body fastening portion and the first body fastening portion are fastened.

6. The connector of claim 4, wherein the first sealing member comprises an elastic member.

7. The connector of claim 4, wherein the first spring is interposed between an upper side of the lower end portion of the piston and the support member, and is configured to compress and decompress.

8. The connector of claim 3, wherein a first pressure sensor is positioned at a lower end portion of the connection cylinder, and is configured to detect a pressure at which the lower end portion of the connection cylinder is in contact with an upper surface of the first body when the second body fastening portion and the first body fastening portion are fastened.

9. The connector of claim 3, wherein the first body fastening portion comprises:
a hydraulic cylinder fixedly connected to the first body, the hydraulic cylinder having a hollow formed therein, and having an opening formed at an upper end of the hydraulic cylinder;
a second sealing member configured to seal the opening of the hydraulic cylinder, and being positioned so that the hydraulic cylinder is moved when the second body fastening portion and the first body fastening portion are fastened;
a pad positioned at a lower end of the hydraulic cylinder and protruding to an outside of the hydraulic cylinder to be in contact with the inner circumferential surface of the connection cylinder so that the hydraulic cylinder and the connection cylinder are fastened and fixed when the second body fastening portion and the first body fastening portion are fastened; and
a second spring positioned on a lower surface of the first sealing member, wherein the second spring is configured to be compressed between the first sealing member and the first body when the second body fastening portion and the first body fastening portion are fastened.

10. The connector of claim 9, wherein when the second body fastening portion and the first body fastening portion are fastened, the first sealing member is in contact with the piston and is configured to move relative to the hydraulic cylinder.

11. The connector of claim 9, wherein the pad protrudes to the outside by a hydraulic pressure when the second body fastening portion and the first body fastening portion are fastened.

12. The connector of claim 9, wherein the pad is made of an elastic pad or a drum brake.

13. The connector of claim 9, wherein a first pressure sensor is positioned at the pad and configured to detect a pressure at which the pad is in contact with the inner circumferential surface of the connection cylinder when the second body fastening portion and the first body fastening portion are fastened.

14. The connector of claim 9, wherein the first body fastening portion is inserted into the first body to be fixedly installed at the first body, and a rubber packing is positioned on an inner outer circumferential surface of the first body into which the first body fastening portion is inserted, and an outer circumferential surface of the connection cylinder is in contact with the rubber packing when the second body fastening portion and the first body fastening portion are fastened.

15. The connector of claim 14, further comprising a fluid hose positioned on an inner circumferential surface of the hydraulic cylinder, wherein the fluid hose extends toward the first body and includes a fluid flowing therethrough.

16. The connector of claim 9, wherein the first body fastening portion is inserted into and fixedly connected to the first body, a cross-section of the first body into which the first body fastening portion is inserted has a trapezoidal shape, and a cross-section of the connection cylinder of the second body fastening portion corresponding to the first body fastening portion has a trapezoidal shape corresponding to the cross-section of the first body.
